(19) United States
(12) Patent Application Publication
(10) Pub. No.: US 2005/0261042 A1
(43) Pub. Date: Nov. 24, 2005

(54) Sliding apparatus for mobile phone

(75) Inventor: Hyung Chan Kim, Seoul (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: WOOJEON TECH CO., LTD., Seoul (KR)

(21) Appl. No.: 11/008,042

(22) Filed: Dec. 9, 2004

(30) Foreign Application Priority Data
May 21, 2004 (KR) 2004-0036250

(51) Int. Cl. H04Q 7/20

(52) U.S. Cl. 455/575.4; 455/575.1

(57) ABSTRACT

A sliding apparatus for a mobile phone consisting of a slide case and a slider vertically moving by being mounted on the slide case, and which can open and shut a telephone transmitter by pushing up or down a receiver of the mobile phone. Since the sliding apparatus for the mobile phone in accordance with the present invention consists of the slide case and the slider only, it can reduce the number of entire components with a simple assembling process, thereby lowering a product cost.

### CROSS-REFERENCE TO RELATED PATENT APPLICATIONS

This patent application claims priority to Korean Patent Application No. 2004-0036250, filed May 21, 2004, which is hereby incorporated by reference.

### BACKGROUND OF THE INVENTION

The present invention generally relates to a sliding apparatus for a mobile phone, and more particularly, to a sliding apparatus for a mobile phone consisting of a slide case and a slider vertically moving by being mounted on the slide case, and which can open and shut a telephone transmitter by pushing up or down a receiver of the mobile phone.

Mobile phones have become the necessities of life by supplying various additional functions such as wireless Internet or multimedia while realizing mobile convenience for the user. They have been changed in various structures to user convenience and functionality. For instance, bar-type, flip-type, and folder-type mobile phones have been suggested.

Among the above mobile phones, the bar-type mobile phone has a problem that a keypad is exposed outside, thus, it is operated regardless of the user's intention or damaged easily. To solve this problem, the flip-type cellular phone capable of opening/shutting a keypad has been provided. However, the flip-type mobile phone has a too long body, deteriorating portability. To complement the flip-type mobile phone, the folder-type mobile phone has been suggested, which has a hinge between a receiver where an LCD screen is disposed and a transmitter where a keypad is installed.

But, the hinge of the folder-type mobile phone is easily susceptible to damage when the receiver is frequently opened and shut, and furthermore, the user should open the receiver to use petty functions of the mobile phone, for instance, even when the user confirms a text message or confirms the time. Therefore, to address such a problem, a mobile phone (dual folder-type mobile phone) on which an outer LCD screen is mounted has been provided. Nevertheless, the dual folder-type mobile phone has a weak point of inevitably opening a receiver to use various functions of the mobile phone because size of the outer LCD screen is small. And, when the size of the outer LCD screen is wider, the price gets higher as well.

To address the above problem, a sliding-type mobile phone has been suggested, which can open and shut a keypad of a transmitter by sliding a receiver to vertically move it while the receiver is coupled with the transmitter. In case of the above sliding-type mobile phone, an LCD screen of the receiver is exposed outside in ordinary times. So, it is convenient to use functions of the mobile phones when confirming a text message, and it is easy to carry the sliding-type mobile phone since its size is not different from the folder-type mobile phone, particularly.

Such a sliding-type mobile phone disposes a sliding apparatus between a receiver and a transmitter to slide the receiver. A representative example of an existing sliding apparatus for a mobile phone has been shown in the Korea Patent Application No. 2002-0016667 (hereinafter, called “prior art”).

The sliding apparatus shown in the prior art comprises a slide case where a slide cover and a lock plate are overlapped and fixed together, a slider slidingly received within the slide case in pressure welding state, a locking unit installed between the slider and the slide case, and pins mounted on the slider and protruded outside the slide case by piercing through guide long holes installed on the slide case.

Still, the prior art has difficulty in fixing the slide cover to a lock plate of the slide case while the slider is received in the slide case, and has many components, resulting in a lot of molding cost of the components.

### BRIEF SUMMARY OF THE INVENTION

It is therefore an object of the present invention to provide a sliding apparatus for a mobile phone which can reduce the number of components and realize a simple assembling process in a sliding apparatus for vertically sliding a receiver by being mounted between the receiver and a transmitter of the mobile phone.

### SUMMARY OF THE INVENTION

To achieve the above object, in a sliding apparatus for a mobile phone which can open and shut a transmitter by vertically sliding a receiver by being mounted as more than one between the transmitter and the receiver of the mobile phone, the sliding apparatus for the mobile phone in accordance with the present invention consists of: a slide case configured in long plate shape; and a slider disposed on an upper side of the slide case, and wherein both sides of the slider are coupled with guide grooves of the slide case to slide along the guide grooves. The slide case comprises: toward an upper part from both sides, the guide grooves opposite to each other toward a vertical direction of the slide case and configured in long groove shape; a first stopper groove formed to vertically pierce through in a spaced position at certain intervals toward an inner side from a first section; and a second stopper groove formed to vertically pierce through in a spaced position at certain intervals toward an inner side from a second section, an opposite section to the first section. The slider is configured in flat plate shape, comprising: a hooking member having a hooking projection protruded in predetermined size toward a lower part on a center of a lower side; and an elastic member disposed on an upper side of the hooking member, and wherein a central part of a flat plate soars toward an upper part. Both sides of the hooking member and the elastic member are coupled together with the guide grooves, and the hooking projection is coupled to the first stopper groove and the second stopper groove, respectively.

At this time, it is desirable to form the hooking projection by bending the central part of the hooking member toward a lower part.

Moreover, to accomplish the above object, another embodiment of a sliding apparatus for a mobile phone in accordance with the present invention includes a slide case configured in long plate shape and a slider disposed on an upper side of the slide case and wherein both sides thereof are coupled with guide grooves of the slide case to slide along the guide grooves. The slide case comprises: toward an upper part from both sides, the guide grooves opposite to each other toward a vertical direction of the slide case and configured in long groove shape; a first stopper projection protruded in predetermined size toward an upper part in a spaced position at certain intervals toward an inner side from a first section of an upper side; and a second stopper projection protruded in predetermined size toward an upper part in a spaced position at certain intervals toward an inner side from a second section of an upper side, an opposite section to the first section of the upper side. The slider is configured in flat plate shape, comprising: a hooking member including a first hooking projection protruded in predetermined size toward a lower part in a first section of a lower side and a second hooking projection protruded in predetermined size toward a lower part in a second section of a lower side, an opposite section to the first section of the lower side; and an elastic member disposed on an upper side of the hooking member, and wherein a central part of a flat plate soars toward an upper part. Both sides of the hooking member and the elastic member are coupled together with the guide grooves. The first hooking projection and the second hooking projection are coupled with the first stopper projection and the second stopper projection, respectively.

On this occasion, it is desirable to form the first hooking projection by bending the first section of the hooking member toward the lower part and to form the second hooking projection by bending the second section of the hooking member toward the lower part.

Desirably, the slide case has a coupling projection protruded in predetermined size in the first section, and a coupling hole formed to vertically pierce through such that a coupling portion can be inserted into the second section. In this case, the coupling projection is formed in ‘ [symbol] ’ shape. In addition, it is desirable for the hooking member to have more than one insertion groove, which is caved in to insert the coupling portion, on an upper side, and for the elastic member to be formed in reverse ‘V’ shape.

### BRIEF DESCRIPTION OF THE DRAWINGS

The invention, together with further aspects and advantages thereof, may best be understood by reference to the following description taken in conjunction with the accompanying drawings in which:

FIG. 1 is a perspective view of a sliding apparatus for a mobile phone in accordance with the present invention;

FIG. 2 is an exploded perspective view of a sliding apparatus for a mobile phone in accordance with the present invention;

FIG. 3 is a sectional view of a sliding apparatus for a mobile phone in accordance with the present invention;

FIG. 4 is a perspective view showing another embodiment of a sliding apparatus for a mobile phone in accordance with the present invention;

FIG. 5 is an exploded perspective view showing another embodiment of a sliding apparatus for a mobile phone in accordance with the present invention;

FIG. 6 is a sectional view showing another embodiment of a sliding apparatus for a mobile phone in accordance with the present invention;

FIG. 7 is an exploded perspective view of a mobile phone where a sliding apparatus for the mobile phone is mounted according to the present invention; and

FIG. 8 is a diagram for illustrating opening/shutting of a mobile phone in accordance with an operation of a sliding apparatus for the mobile phone in accordance with the present invention.

### REFERENCE LIST

| | |
|---|---|
| 10: slide case | 11a, 11b: guide grooves |
| 14a, 14b: stopper grooves | 20, 40: sliders |
| 21: hooking member | 22a, 22b: insertion grooves |
| 23: hooking projection | 25: elastic member |
| 50: receiver | 52: first plate |
| 60: transmitter | 62: second plate |

### DETAILED DESCRIPTION OF THE INVENTION

The present invention will now be described in detail with reference to exemplary preferred embodiments as illustrated in the accompanying drawings.

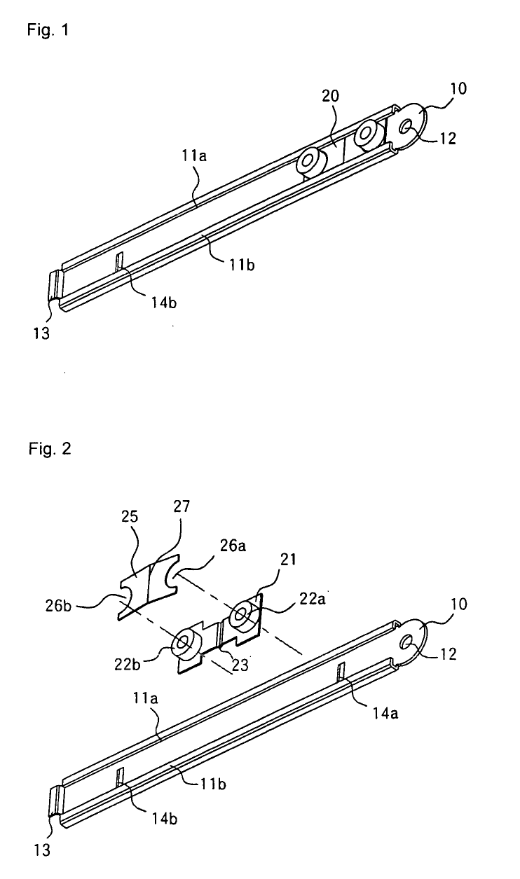

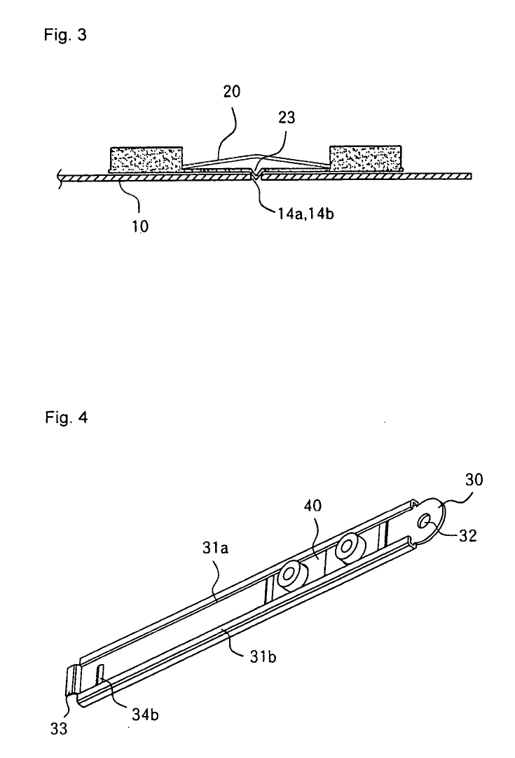

FIG. 1 is a perspective view of a sliding apparatus for a mobile phone in accordance with the present invention, and FIG. 2 is an exploded perspective view of a sliding apparatus for a mobile phone in accordance with the present invention. Also, FIG. 3 is a sectional view of a sliding apparatus for a mobile phone in accordance with the present invention, showing a vertical direction of the sliding apparatus for the mobile phone. In reference to FIG. 1 through FIG. 3, the sliding apparatus for the mobile phone in accordance with the present invention will be described as follows.

The sliding apparatus for the mobile phone in accordance with the present invention consists of a long plate-shaped slide case (10) and a slider (20) vertically moving while sliding in connection with the slide case.

The slide case (10) in accordance with the present invention is configured in long flat plate shape, and has guide grooves (11a,11b) formed in long groove shape by being opposite to each other in vertical direction of the slide case on both sides thereof. Right/left sides of the slider (20) are coupled with the guide grooves (11a,11b), so that the slider can vertically move without being separated. It is desirable to form the guide grooves over a whole surface of right/left sides of the slide case.

Fixing units for fixing/mounting the slide case to/on a receiver of the mobile phone are comprised in both sections of the slide case (10). More specifically, a coupling hole (12) formed to vertically pierce through is comprised in a first section to insert a coupling portion such as a screw, and a coupling projection (13) protruded in predetermined size is comprised in a second section. At this point, the coupling projection (13) is formed in ‘ [symbol] ’ shape, thereby preventing the slider (20) from being separated from the second section of the slide case (10). Furthermore, since the coupling portion is inserted into the coupling hole (12), it can prevent the slider from being separated from the first section of the slide case. Meanwhile, it is natural to comprise the coupling hole (12) or the coupling projection (13) in both sections of the slide case (10). Besides, separation prevention ends protruded in predetermined size toward an upper part can be separately comprised in both sections of the slide case to prevent the slider (20) from being separated.

A first stopper groove (14a) and a second stopper groove (14b) vertically piercing through the slide case are comprised in spaced positions at certain intervals from the coupling hole (12) and the coupling projection (13) of both sections of the slide case (10). At this moment, the first stopper groove (14a) and the second stopper groove (14b) can be formed in cave-in shape as much as predetermined depth without vertically piercing through.

The slider (20) in accordance with the present invention is a configuration portion vertically moving as sliding while both sides thereof are coupled with the guide grooves (11a,11b) of the slide case (10), consisting of a hooking member (21) and an elastic member (25).

The hooking member (21) is a configuration portion sliding in vertical direction of the slide case while both sides thereof are coupled with the guide grooves (11a,11b) of the slide case (10), comprising more than one insertion groove (22a,22b) where screw grooves are formed to insert/fix a coupling portion such as a screw to connect with a transmitter of a mobile phone on an upper side. Also, a hooking projection (23) protruded in predetermined size toward a lower side is comprised in a central part of the hooking member (21), in order to be hooked over the first stopper groove (14a) and the second stopper groove (14b) of the slide case (10). Desirably, the hooking member (21) is manufactured in flat plate shape and the hooking projection (23) is formed in a shape that the central part of the hooking member can get bent toward the lower part. In this case, the hooking projection (23) has an elastic force, thereby realizing an easy hooking and separating process to the first stopper groove (14a) and the second stopper groove (14b). Desirably, so that the hooking projection (23) can be hooked or separated by smoothly going over the stopper grooves (14a,14b), a boundary portion (part where the hooking member gets bent toward a lower part to form the hooking projection) between the hooking member and the hooking projection is formed at an obtuse angle. Also, it is desirable to use a metal material for the hooking member (21) to increase elasticity of the hooking projection (23).

The elastic member (25) is a configuration portion for preventing the hooking member from vertically sliding down the slide case by complementing a separation between the guide grooves (11a,11b) and side sections of the hooking member by being mounted in an upper part of the hooking member (21). Since the hooking member (21) is configured in plate shape and is formed with the hooking projection (23) in a central part, it is difficult to determine a height of the guide grooves (11a,11b) and furthermore, a separation occurs between the hooking member and the guide grooves while being coupled with the guide grooves. In detail, given that a thickness of a plate type of the hooking member where the hooking projection is not formed is ‘t1’ and a height of the hooking projection is ‘t2’, the hooking projection is coupled with the stopper grooves in a position where the stopper grooves (14a,14b) are formed. Thus, an entire height of the hooking member over the slide case becomes ‘t1’. Besides, since the hooking projection is supported by an upper side of the slide case in a position where the stopper grooves are not formed, the entire height of the hooking member becomes ‘t1+t2’. Accordingly, supposing that heights of the guide grooves (11a,11b) are ‘t1+t2’, a separation occurs between the guide grooves and the hooking member in the position where the stopper grooves (14a,14b) are formed, resulting in a loose coupling state and a high frictional force between the hooking member and the slide case while the slider slides down, because the hooking member is in the same height as the guide grooves. Thus, an excessive force is required to vertically slide the slider, giving inconvenience to the user. Therefore, the guide grooves (11a,11b) should be higher than the height ‘t1+t2’ while complementing the separation between the guide grooves and the hooking member (21) with the elastic member (25). As a result, the slider can easily slide down and the hooking projection (23) can be easily hooked over and separated from the stopper grooves (14a,14b).

The elastic member (25) is formed in a shape that a flat plate-shaped central part (27) soars toward an upper part. Desirably, it is configured in reverse ‘V’ shape. Thus, the elastic member functions as a leaf spring. Moreover, both sections (26a,26b) of the elastic member (25) are caved in with the same shape as edges of insertion grooves (22a,22b) of the hooking member (21), so that the elastic member can be easily mounted on an upper side of the hooking member. Desirably, the elastic member is made of a metal material to increase elasticity.

Hence, both sides of the hooking member (21) and the elastic member (25) are coupled together with the guide grooves (11a,11b) of the slide case (10), and the elastic member supports the hooking member and the guide grooves by complementing the separation, thereby preventing the hooking member from sliding down within the guide grooves owing to a loose state. Likewise, since the elastic member (25) supports the guide grooves (11a,11b) and the hooking member (21) while being coupled with the stopper grooves (14a,14b), the coupled state of the hooking projection can be stably maintained. Meanwhile, a frictional force caused on a contacted side between the slider and the slide case (10) while the slider (10) slides down is reduced by an elastic force of the elastic member (25), being controllable at a proper usable level.

An operation of the sliding apparatus for the mobile phone in accordance with the present invention will be simply described below.

The slider (20) in accordance with the present invention slides down in vertical direction by an external force while both sides thereof are coupled with the guide grooves (11a,11b) of the slide case (10). At this time, if the hooking projection (23) exposed to a lower side of the slider is adjacent to the first stopper groove (14a) or the second stopper groove (14b) and the external force is continuously applied, the hooking projection goes over the stopper grooves to be hooked over. Consequently, the slider (20) stops a sliding motion and halts in a specific position (position where the hooking projection is coupled with the stopper grooves), stably maintaining an open or a shut state of a mobile phone receiver unless the user applies a force.

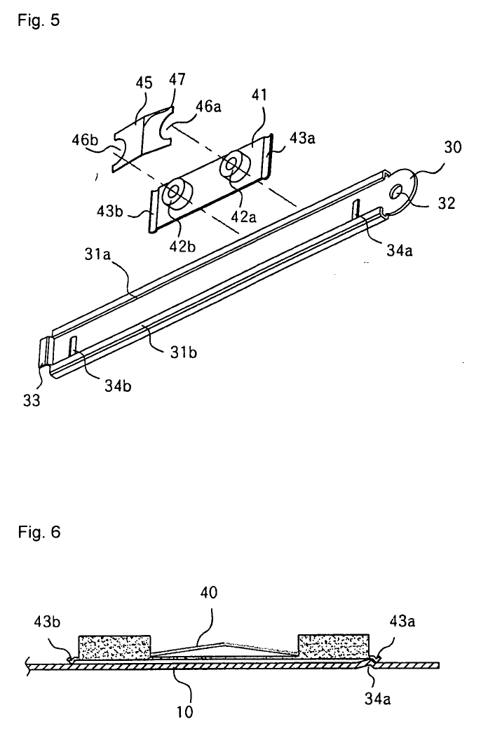

FIG. 4 is a perspective view showing another embodiment of a sliding apparatus for a mobile phone in accordance with the present invention, and FIG. 5 is an exploded perspective view showing another embodiment of a sliding apparatus for a mobile phone in accordance with the present invention. Likewise, FIG. 6 is a section view showing another embodiment of a sliding apparatus for a mobile phone in accordance with the present invention, illustrating a vertical direction of another embodiment of the sliding apparatus for the mobile phone. Hereinafter, in reference to FIG. 4 through FIG. 6, another embodiment of the sliding apparatus for the mobile phone in accordance with the present invention will be described. However, detailed explanations on the common parts with the sliding apparatus of FIG. 1 through FIG. 3 will be omitted.

Another embodiment of the sliding apparatus for the mobile phone in accordance with the present invention consists of a slide case (30) and a slider (40).

The slide case (30) in accordance with the present invention has guide grooves (31a,31b) formed in vertical direction of the slide case on both sides like shown in the above, and comprises a coupling hole (32) and a coupling projection (33) on both sections, respectively.

As well, a first stopper projection (34a) and a second stopper projection (34b) protruded in predetermined size toward an upper part are comprised in a spaced position at certain intervals from the coupling hole (32) and the coupling projection (33) of both sections on an upper side of the slide case.

The slider (40) in accordance with the present invention vertically moves as sliding down while both sides thereof are coupled with the guide grooves (41a,41b) of the slide case (30), and consists of a hooking member (41) and an elastic member (45).

The hooking member (41) is configured in plate shape, and vertically slides down the slide case (30) in connection with the guide grooves (31a,31b), comprising more than one insertion groove (42a,42b) where screw grooves are formed to insert/fix a coupling portion such as a screw to couple with a mobile phone transmitter. Besides, a first hooking projection (43a) and a second hooking projection (43b) protruded toward a lower part are comprised in both sections of the hooking member (41), in order to be hooked over the first stopper projection (34a) and the second stopper projection (34b). That is, through the first hooking projection (43a) and the second hooking projection (43b), both sections of the hooking member (41) are in downward-bent shape. Desirably, both sections (both sections of the hooking member (41) of each of the hooking projections (43a,43b) are formed in upward-bent shape, so that the first hooking projection (43a) and the second hooking projection (43b) can smoothly go over the stopper projections (34a,34b) to be coupled and separated therefrom. So, the sections of the hooking projections (43a,43b) can smoothly go over the stopper projections (34a,34b) without any interruption, while preventing an excessive force from being applied. And, it is desirable to use a metal material as the hooking member (41) to increase elasticity of the hooking projections (43a, 43b).

A flat plate-shaped central part (47) of the elastic member (45) soars toward an upper part, and the elastic member (45) complements a separation between the guide grooves (31a,31b) and side sections of the hooking member by being mounted on an upper part of the hooking member (41). Both sections (46a,46b) of the elastic member (45) are caved in with the same shape as edges of the insertion grooves (42a,42b) of the hooking member (41), being easily coupled with the hooking member. Since configurations and functions of the elastic member have been already described above, detailed explanations will be omitted.

An operation of another embodiment of a sliding apparatus for a mobile phone in accordance with the present invention will be simply described below.

The slider (40) in accordance with the present invention does a sliding motion in vertical direction along the guide grooves by an externally applied force while both sides thereof are coupled with the guide grooves (31a,31b) of the slide case (30). On this occasion, if the hooking projections (43a,43b) of both sections of the slider are adjacent to the stopper projections (34a,34b) and an external force is continuously applied, the sections of the hooking projections go over the stopper projections such that the hooking projections are coupled with the stopper projections. Thus, the slider (20) stops the vertical sliding and halts in a specific position (position where the hooking projections are coupled with the stopper projections). Accordingly, it is possible to stably maintain an open or a shut state of a mobile phone receiver.

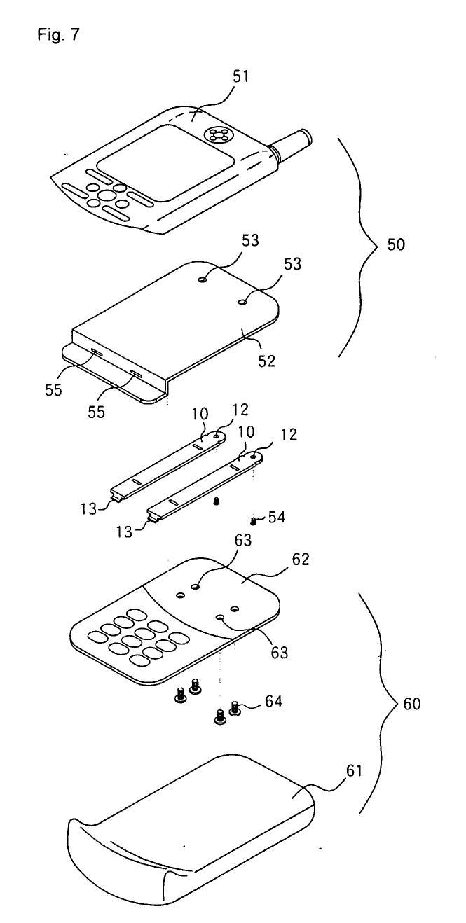

FIG. 7 is an exploded perspective view of a mobile phone where a sliding apparatus for the mobile phone is mounted according to the present invention. Like shown in FIG. 7, the mobile phone having a slide open/shut type consists of a receiver (50) where an LCD screen is installed and a transmitter (60) where a keypad is disposed. In this case, the receiver (50) comprises an upper housing (51) forming an external shape of the receiver and a first plate (52) for fixing/mounting the sliding apparatus to/on a lower side. Meanwhile, the transmitter (60) consists of a lower housing (61) forming an external shape of the transmitter and a second plate (62) for fixing/mounting the sliding apparatus on an upper side and wherein a keypad is disposed. At least more than one sliding apparatus for the mobile phone is mounted between the first plate (52) and the second plate (62), thereby supporting a slide open/shut operation of the receiver (50) and the transmitter (60). Desirably, two sliding apparatuses for the mobile phone are comprised on the right and the left to realize an easy slide open/shut process while increasing stability.

A method of fixing the sliding apparatus for the mobile phone in accordance with the present invention to the first plate (52) and the second plate (62) will be described as follows.

First, a lower side of a slide case (10) of the sliding apparatus for the mobile phone is fixed and mounted to and on a lower side of the first plate (52) of the receiver (50), and an upper side of a slider (20) is fixed and mounted to and on an upper side of the second plate (62) of the transmitter (60).

In order to mount the slide case (10), first, coupling projections (13) are inserted into coupling grooves (55) under the first plate (52). At this time, the coupling grooves (55) are formed by piercing through one vertical side which is in bent shape toward a lower part in vertical direction on a lower end of the first plate (52). Next, the slide case is mounted on the first plate by inserting/fixing coupling portions (54) such as screws into coupling holes (53) of the first plate and coupling holes (12) of the slide case (10).

Then, so as to mount the slider (20) on the second plate (62), coupling portions (64) such as screws are inserted/fixed into coupling grooves (63) of the second plate and insertion grooves (22a,22b) of the slider, so that the slider can be mounted on the second plate.

If screws are used as the coupling portions (54,64) in the above configuration, screw grooves are formed inside the coupling holes (12) of the slide case and the insertion grooves (22a,22b) of the slider.

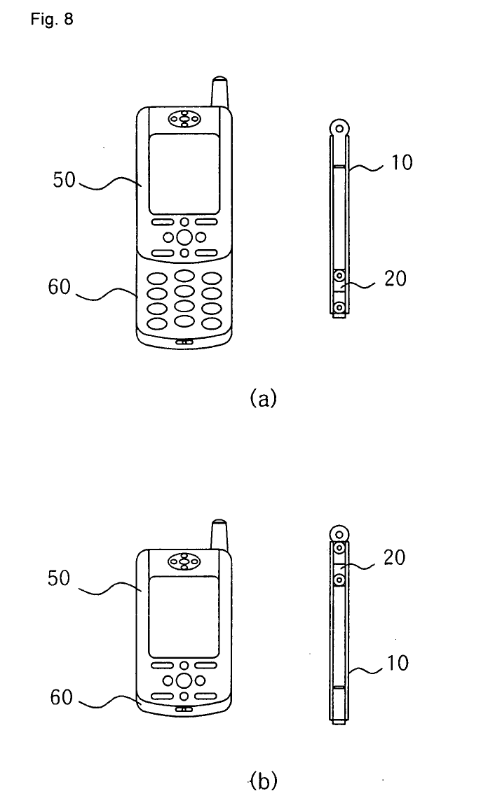

FIG. 8 is a diagram illustrating opening/shutting of a mobile phone in accordance with an operation of a sliding apparatus for the mobile phone in accordance with the present invention. FIG. 8(a) is a diagram illustrating that a receiver (50) of the mobile phone is pushed up by using the sliding apparatus for the mobile phone in accordance with the present invention, and FIG. 8(b) is a diagram illustrating that the mobile phone is shut by putting the receiver (50) down. FIG. 8(a) and FIG. 8(b) illustrate a front view showing an open/shut state of the mobile phone on the left, and illustrate a rear view showing a position of a slider (20) on a slide case (10) while opening/shutting the mobile phone on the right. In other words, since a lower side of the slide case is shown as the front view when the sliding apparatus is illustrated from a front view of the mobile phone, the rear view of the sliding apparatus is illustrated to help understand the present invention. An opening/shutting operation of the mobile phone by using the sliding apparatus for the mobile phone in accordance with the present invention will be described below in reference to FIG. 8(a) and FIG. 8(b).

When the user pushes up the receiver to use the mobile phone while the mobile phone is shut, that is, the receiver (50) of the mobile phone is put down downward, the slide case (10) fixed to the first plate (52) moves upward along the receiver. At this point, the slider (20) fixed to the second plate (62) relatively moves downward. Thus, the slider slides downward along the guide grooves (11a,11b) of the slide case. In the meantime, if the slider and the slide case slide down in opposite direction, the hooking projection (23) of the slider is adjacent to the second stopper groove (14b) of the slide case while continuously sliding down by an external force. Eventually, the hooking projection goes down the second stopper groove to be coupled. On this occasion, the hooking member (21) is pushed downward by the elastic member (25), maintaining a coupled state between the hooking projection and the second stopper groove. Hence, like shown in FIG. 8(a), it is maintained that the slider (20) goes down the slide case (10), and thus, it is stably maintained that the mobile phone receiver (50) is lifted up.

If the receiver (50) is continuously pushed up, a lower end of the slider (20) is hooked over the coupling projection (13) of the second section of the slide case (10), preventing the slider from being separated from the slide case.

Furthermore, like another embodiment of the sliding apparatus for the mobile phone in accordance with the present invention, the slide case (30) moves upward while the receiver (50) is pushed up, and the slider (40) relatively moves downward. Therefore, since a lower section of the slider goes over the second stopper projection (34b), the second hooking projection (43b) is coupled with the second stopper projection.

On the other hand, if the user shuts the mobile phone by putting the receiver down while the receiver (50) is pushed up, the slide case (10) moves downward along the first plate (52), and the slider (20) relatively moves upward along the second plate (62). At this moment, the hooking projection (23) coupled with the second stopper groove (14b) is separated from the second stopper groove by a force applied from the user, and the slider slides upward along the guide grooves (11a,11b). While the slide case and the slider move in opposite direction, the hooking projection (23) of the slider is adjacent to the first stopper groove (14a) of the slide case, and the hooking projection is coupled with the first stopper groove by an external force. Likewise, the hooking member (21) is pushed downward by the elastic member (25), maintaining the coupled state between the hooking projection and the first stopper groove. So, like shown in FIG. 8(b), it is maintained that the slider (20) is pushed upward the slide case (10), and accordingly, it is stably maintained that the mobile phone receiver (50) is put downward.

Meanwhile, when the receiver (50) is continuously put downward, upper ends of the slider (20) are hooked over the coupling holes (12) of the slide case (10) and the coupling portions (54) inserted into the coupling holes (53) of the first plate (52), thereby preventing the slider from being separated from the slide case.

In addition, like another embodiment of the sliding apparatus for the mobile phone in accordance with the present invention, if a force is applied to put the receiver (50) down, the second hooking projection (43b) is separated by going over the second stopper projection (34b) and the slide case (30) goes downward, then the slider (40) relatively goes up along the guide grooves (31a,31b). As a result, the slide case and the slider slide down in opposite direction by an external force, and eventually, an upper section of the slider (40) goes over the first stopper projection (34a), so that the first hooking projection (43a) is coupled with the first stopper projection. Thus, like shown in FIG. 8(b), it is maintained that the receiver (50) is put down.

As described already, a sliding apparatus for a mobile phone in accordance with the present invention consists of a slide case and a slider only, thereby reducing the number of entire components while realizing an easy assembling process and lowering a product cost.

Also, the sliding apparatus for the mobile phone in accordance with the present invention: first, since a hooking projection of the slider is coupled with a first stopper groove or a second stopper groove of the slide case, or a first hooking projection or a second hooking projection of the slider is coupled with a first stopper projection or a second stopper projection of the slide case, upper/lower positions of the slider can be supported to stably maintain an open/shut state of the mobile phone; second, a high frictional force is prevented on a contacted side between the slider and the slide case while the slider slides down by an elastic member of the slider, while generating a proper frictional force, thereby preventing the slider from quickly moving or sliding down in vertical direction on a sudden; third, since it prevents the slider from quickly moving or sliding down in vertical direction, any impact applied to the receiver can be suppressed while improving a sliding sensitivity of the user; fourth, it can prevent the slider from being separated from the slide case while sliding, through separation prevention ends separately comprised in both sections of the slide case or coupling portions inserted into coupling holes and coupling projections of the slide case; and finally, various modifications are available in each configuration part of the slide case and the slider.

While the present invention has been described in connection with a number of embodiments and implementations, the present invention is not so limited but covers various obvious modifications and equivalent arrangements, which fall within the purview of the appended claims.

1. A sliding apparatus for a mobile phone being mounted between a transmitter and a receiver of the mobile phone for opening/shutting the transmitter by vertically sliding the receiver, comprising:
a slide case configured in long plate shape; and wherein
the slide case comprises:
guide grooves, toward an upper part from both sides, being opposite to each other in vertical direction of the slide case, and configured in long groove shape;
a first stopper groove formed to vertically pierce through in a spaced position at certain intervals toward an inner side from a first section; and
a second stopper groove formed to vertically pierce through in a spaced position at certain intervals toward an inner side from a second section, an opposite section to the first section; and
a slider disposed on an upper side of the slide case, and wherein both sides thereof are coupled with the guide grooves, and sliding down the guide grooves; and wherein
the slider comprises:
a hooking member configured in flat plate shape, and having a hooking projection protruded in predetermined size toward a lower part in a central part of a lower end; and
an elastic member disposed on an upper end of the hooking member, and wherein a flat plate-shaped central part thereof soars toward an upper part; and wherein
both sides of the hooking member and the elastic member are coupled together with the guide grooves, and the hooking projection is coupled with the first stopper groove and the second stopper groove, respectively.

2. A sliding apparatus for a mobile phone being mounted between a transmitter and a receiver of the mobile phone as more than one, and for opening/shutting the transmitter by vertically sliding the receiver, comprising:
a slide case configured in long plate shape; and
the slide case comprises:
guide grooves, toward an upper part from both sides, being opposite to each other in vertical direction of the slide case, and configured in long groove shape;
a first stopper projection protruded in predetermined size toward an upper part in a spaced position at certain intervals toward an inner side from a first section of an upper side; and
a second stopper projection protruded in predetermined size toward an upper part in a spaced position at certain intervals toward an inner side from a second section of an upper side, an opposite section to the first section of the upper side; and
a slider disposed on an upper side of the slide case, and wherein both sides thereof are coupled with the guide grooves, and sliding down the guide grooves; and wherein
the slider comprises:
a hooking member configured in flat plate shape, and consisting of a first hooking projection protruded in predetermined size toward a lower part in a first section of a lower end and a second hooking projection protruded in predetermined size toward a lower part in a second section of a lower side, an opposite section to the first section of the lower side; and
an elastic member disposed on an upper side of the hooking member, and wherein a flat plate-shaped central part thereof soars toward an upper part; and wherein
both sides of the hooking member and the elastic member are coupled together with the guide grooves, and the first hooking projection and the second hooking projection are coupled with the first stopper projection and the second stopper projection, respectively.

3. The sliding apparatus of claim 1, wherein the slide cases comprise coupling projections protruded in predetermined size in the first section, and comprise coupling holes formed to vertical pierce through such that coupling portions can be inserted into the second section.

4. The sliding apparatus of claim 3, wherein the coupling projections are in ‘’ shape.

5. The sliding apparatus of claim 1, wherein the hooking members comprise more than one insertion groove caved in to insert coupling portions on an upper side thereof.

6. The sliding apparatus of claim 1, wherein the elastic members are in reverse “V” shape.

7. The sliding apparatus of claim 1, wherein the hooking projection is formed by bending a central part of the hooking member downward.

8. The sliding apparatus of claim 2, wherein the first hooking projection is formed by bending the first section of the hooking member downward, and the second hooking projection is formed by bending the second section of the hooking member downward.

9. The sliding apparatus of claim 2, wherein the slide cases comprise coupling projections protruded in predetermined size in the first section, and comprise coupling holes formed to vertical pierce through such that coupling portions can be inserted into the second section.

10. The sliding apparatus of claim 9, wherein the coupling projections are in ‘ [symbol] ’ shape.

11. The sliding apparatus of claim 2, wherein the hooking members comprise more than one insertion groove caved in to insert coupling portions on an upper side thereof.

12. The sliding apparatus of claim 2, wherein the elastic members are in reverse “V” shape.

13. The sliding apparatus of claim 2, wherein the hooking projection is formed by bending a central part of the hooking member downward.
